(19) United States
(12) Patent Application Publication
(10) Pub. No.: US 2012/0129141 A1
(43) Pub. Date: May 24, 2012

(54) e-Learning System

(76) Inventor: Doreen Granpeesheh, Woodland Hills, CA (US)

(21) Appl. No.: 12/954,520

(22) Filed: Nov. 24, 2010

(51) Int. Cl. G09B 5/00

(52) U.S. Cl. 434/308

(57) ABSTRACT

An e-Learning system provides a dashboard adapted to permit user navigation to a multiplicity of lessons. Each lesson is presented in a web page as an audio-video program and a text field adapted to permit a user to enter notes which watching the audio-video program is provided on the web page. Individual quizzes associated with each of the lessons are provided and once the individual quizzes have been completed the user may take a comprehensive final exam. Any notes taken during the lessons are accessible to the user during the quizzes and the final exam.

### FIELD OF THE INVENTION

The present invention relates to computer-based methods and systems for providing training materials for educators and, in one particular embodiment, for providing such materials to prospective behavioral educators of children with developmental disorders.

### BACKGROUND

Applied behavior analysis (ABA) can be regarded as the application of behaviorism, the study of human behavior, to affect, enhance or eliminate a particular behavior in an individual. ABA has been used in connection with a variety of activities, including teaching children with developmental disorders, such as autism. ABA is not, however, a specific program or curriculum for teaching an autistic child desired skills; rather, it is a framework for understanding how an appropriate program can be developed. In order to develop ABA-based curriculums, educators need to be provided facilities to learn how to develop same.

### SUMMARY OF THE INVENTION

In various embodiments, the present invention provides a computer-based system, e.g., a server or other system, which includes a processor and a storage medium communicatively coupled thereto. The storage medium stores computer-executable instructions, which when executed by the processor cause the processor to execute a module configured as an e-Learning system that provides a client computer system with a web page configured as a dashboard that is adapted to permit user navigation to a multiplicity of lessons, each such lesson having an associated web page that includes a viewing area for an audio-video program and a text field adapted to permit a user to enter notes which watching the audio-video program. The dashboard may be further configured to permit user navigation to individual quizzes associated with each of the lessons, wherein graphical elements to facilitate such user navigation to a respective one of the individual quizzes is enabled on the dashboard only after all prerequisites for the respective one of the individual quizzes have been completed. Likewise, the dashboard may be configured to permit user navigation to a final exam, which is comprehensive for all of the lessons, wherein a graphical element to facilitate user navigation to the final exam is enabled on the dashboard only after all of the individual quizzes have been successfully completed.

The dashboard may be configured to graphically depict user progress through the individual lessons and completion of the individual quizzes. Any notes taken by a user are accessible by the user while taking one of the quizzes and/or the final exam.

In one particular embodiment, the lessons comprise training materials for prospective behavioral educators of individuals with developmental disorders. This and further embodiments of the invention are discussed in greater detail below.

### BRIEF DESCRIPTION OF THE DRAWINGS

The present invention is illustrated by way of example, and not limitation, in the figures of the accompanying drawings in which:

FIG. 1 illustrates an example of a user interface for in accordance with an embodiment of the present invention;

FIG. 2 illustrates an example of a user interface for in accordance with an embodiment of the present invention;

FIG. 3 illustrates an example of a user interface for in accordance with an embodiment of the present invention;

FIG. 4 illustrates additional aspects of a user interface for in accordance with an embodiment of the present invention;

FIG. 5 illustrates still a further aspect of a user interface in accordance with an embodiment of the present invention;

FIG. 6 illustrates an example of a an example of a user interface for in accordance with an embodiment of the present invention;

FIG. 7 illustrates aspects of an example of a user interface for in accordance with an embodiment of the present invention;

FIG. 8 illustrates aspects of an example of a user interface for in accordance with an embodiment of the present invention;

FIG. 9 illustrates aspects of a treatment progress chart constructed in accordance-with an embodiment of the present invention;

FIG. 10 illustrates an example of a computer network in which embodiments of the present invention may find application and use;

FIG. 11 illustrates an example of a computer system suitable for configuration in accordance with embodiments of the present invention;

FIG. 12 illustrates a software architecture of a computer system configured in accordance with an embodiment of the present invention;

FIG. 13 illustrates an overview of a server-based application configured in accordance with an embodiment of the present invention; and

FIG. 14 illustrates navigation options within an e-Learning system configured in accordance with an embodiment of the present invention.

### DETAILED DESCRIPTION

Described herein are computer-based methods and systems (sometimes referred to as e-Learning systems) for providing training materials for educators and, in one particular embodiment, for providing such materials to prospective behavioral educators of individuals (e.g., children) with developmental disorders. Such training materials can be used to instruct the prospective educators in ABA and how it is used to teach skills to said children, and to facilitate on-line assessment of the prospective educators' mastery of the subject matter of the training materials. In various embodiments of the invention, the present system is made available through a Web portal or other computer-based resource (such as a client computer system), accessible to the prospective educators, therapists, parents, physicians, and others involved with the subject children for which the training programs are intended. The portal allows for access to various training modules, each of which may be made up of one or more lessons, and the assessment tools which can be used to determine a prospective educator's mastery of the subject matter of the training materials based on answers to various assessment questions. Thus, the present invention provides an e-Learning system that is especially well adapted for ABA-based program training but which can also be used in connection with other educational materials.

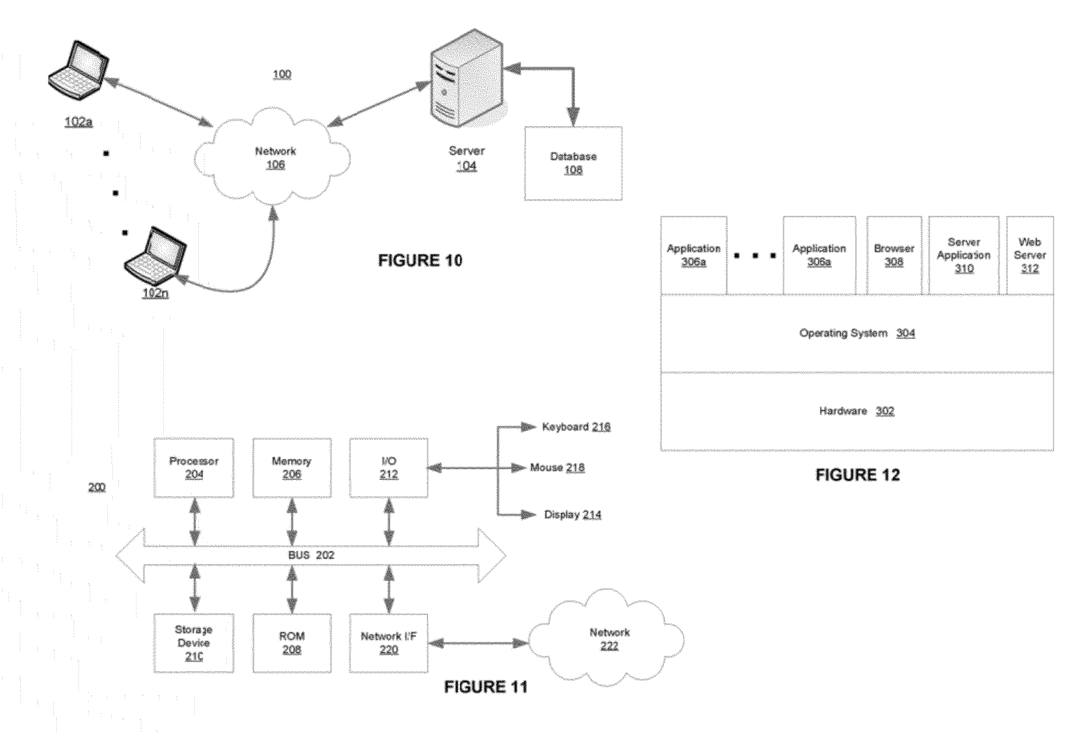

Before describing aspects of the present invention in detail, it is helpful to first discuss the environment in which embodiments of the invention operate. FIG. 10 is a simplified illustration of a computer network 100 which is such an environment. Network 100 includes one or more client computer systems 102a-102n, which may be used by prospective educators and others seeking to access a server 104 at which an instantiation of a computer-based application which provides the e-Learning features discussed above may be installed and accessible. Such access may be via a computer network or network of networks 106, such as a local and/or wide area network. In some cases, network 106 may be or include the network of networks commonly known as the Internet. In other instances, network 106 may be a local area network (LAN) of an enterprise and/or a virtual LAN which is instantiated over the Internet or other networks of networks. Server 104 is communicatively coupled to a database 108, which may store records (such as notes taken by those participating in training sessions) associated with the e-Learning system, as described further below. Client computers 102a-102n may be any form of computer-based system, including personal computers, laptop computers, net book computers, mobile devices, smart phones, and the like. Generally, a client computer 102 will run a Web browser application, through which the application running on server 104 may be accessed, however, in some instances, client computers 102 may run a client application specially configured to interface with the application running on server 104.

FIG. 11 is a block diagram illustrating an example of a computer system 200. Any of client computer systems 102a-102n and/or server 104 may be configured in the manner described for computer system 200.

Computer system 200 includes a bus 202 or other communication mechanism for communicating information, and a processor 204 coupled with the bus 202 for processing information. Computer system 200 also includes a main memory 206, such as a random access memory (RAM) or other dynamic storage device, coupled to the bus 202 for storing information and instructions to he executed by processor 204. Main memory 206 also may be used for storing temporary variables or other intermediate information during execution of instructions to be executed by processor 204. Computer system 200 further includes a read only memory (ROM) 208 or other static storage device coupled to the bus 202 for storing static information and instructions for the processor 204. A computer-readable storage device 210, such as a magnetic disk or optical disk, is provided and coupled to the bus 202 for storing information and instructions.

Computer system 200 may be coupled via the bus 202, either directly or via an input/output module 212, to a display 214, such as a flat panel display, for displaying information to a computer user. An input device 216, including alphanumeric and other keys, is coupled to the bus 202 for communicating information and command selections to the processor 204. Another type of user input device is cursor controller 218, such as a mouse, a trackball, track pad, or cursor direction/control keys for communicating direction information and command selections to processor 204 and for controlling cursor movement/selection operations on the display 214.

As should be apparent, aspects of the present invention involve computer software running on server 104. That software may take the form of computer-executable instructions stored in main memory 206 and/or storage device 210, to be executed by processor 204. In other instances, the instructions may be stored on other computer-readable media, such as a floppy disk, a flexible disk, a hard disk, magnetic tape, or any other magnetic medium, a CD-ROM or DVD-ROM, flash memory, or any other physical medium adapted to store computer-readable instruction and from which a computer processor can read. Execution of the sequences of instructions contained in the main memory 206 causes the processor 204 to perform the processes described herein to provide training materials, on-line assessment tools, and/or individualized curricula. In alternative embodiments, hard-wired circuitry may be used in place of or in combination with computer software instructions to implement the invention. Thus, embodiments of the invention are not limited to any specific combination of hardware circuitry and software.

The algorithms and processes presented herein may be implemented in hard-wired circuitry, by specially programming a general-purpose computer system or by any combination of hardware and software. One of ordinary skill in the art will immediately appreciate that the invention can be practiced with computer system configurations other than those described above, including hand-held devices, multiprocessor systems, microprocessor-based or programmable consumer electronics, digital signal processor-based devices, personal computers, minicomputers, mainframe computers, etc. The invention can also be practiced in distributed computing environments where tasks are performed by remote processing devices that are linked through a communications network. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Computer system 200 also includes a network interface 220 coupled to the bus 202. Network interface 220 provides a two-way data communication path for computer system 200 to/from a network 222. For example, network interface 220 may be an integrated services digital network (ISDN) card or a modem to provide a data communication connection to a corresponding type of telephone line. As another example, communication interface 220 may he a LAN card to provide a data communication connection to a compatible LAN. Wireless communication links may also be implemented. In any such implementation, network interface 220 sends and receives electrical, electromagnetic or optical signals which carry digital data streams representing various types of information. In one embodiment, network 222 may be network 106, or may be communicatively coupled thereto.

FIG. 12 shows an architecture view of computer system 200. The various hardware components of computer system 200 are represented as a hardware layer 302. An operating system 304 abstracts the hardware layer and acts as a host for various applications 306a-306m, that run on computer system 200. In the case of a client computer system, the operating system also acts as a host for a Web browser application 308, while in the case of the server 104, the operating system acts as a host for a server application 310 configured to perform the processes described herein to provide training materials, on-line assessment tools, and/or individualized curricula responsive to requests and other information received from a client computer system. For the server 104, the operating system may also host a web server application 312, which provides access from the client computers via web browsers. In other instances, the web server may be hosted on a separate server (not shown in detail), which is communicatively coupled to a server hosting application 310.

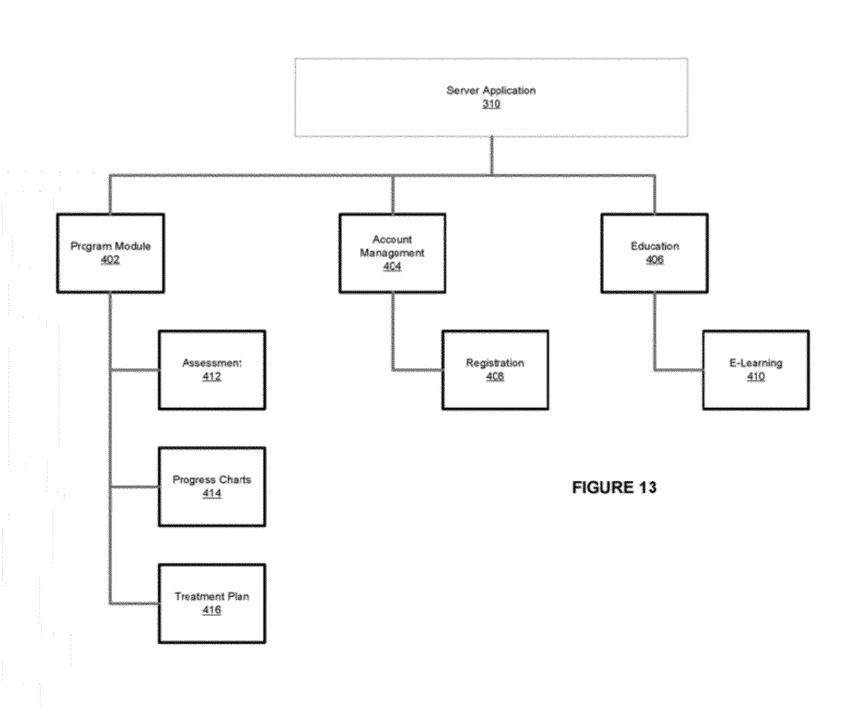

FIG. 13 provides an overview of the server-based application 310 in greater detail. The application includes a program module 402, an account management module 404, and an education module 406. Of course, other modules may also be included but are not described herein in detail so as not to distract from the salient features of the present invention. Further, in some instances, the education module 406 may be a separate application from server application 310.

Account management module 404 includes a registration module 408. The registration module 408 allows users to set up accounts with the system, maintain user names, passwords and other information needed to access the services provided by the present system. The precise details of the registration module are not critical to the present invention.

Education module 406 includes an e-Learning module 410, which provides users access to educational materials. These materials may provide training in ABA and its use in developing programs to teach skills to children with developmental disorders. Topics of such educational materials may include:
Autism and how it is diagnosed,
Introduction to ABA and its principles,
Assessment and identification of skill targets,
Teaching Paradigms, including:
   Natural Environment Training (NET),
   Discrete Trial Training (DTT),
   Fluency-Based Instruction (FBI),
Procedures discrimination training, including:
   Prompting and Fading (prompts are generally regarded as cues to encourage a desired response from an individual, and may be categorized from most intrusive to least intrusive, with a goal of teaching desired behavior to be systematic fading of prompt methods towards independence),
   Shaping (the gradual modification of existing behavior into desired behavior),
   Chaining (linking of incremental activities to be learned in order to achieve an overall desired skill),
Generalization and Maintenance (the expansion of a child's performance abilities beyond the initial conditions set for acquisition of a skill),
Functional behavioral assessment (FBA) (e.g., assessment of types and sources of reinforcement for challenging behaviors to be as the basis for intervention efforts designed to decrease the occurrence of these behaviors),
Interventions for challenging behavior (challenging behaviors are generally those which are culturally abnormal and are of such intensity, frequency or duration that the physical safety of the subject individual or others is placed in serious jeopardy, or behavior which is likely to seriously limit or deny access to the use of ordinary community facilities), and
Data collection, etc.
   Of course, in other instantiations, different and/or additional program materials may be provided. The e-Learning materials may be provided in any convenient fashion, for example as downloadable and/or printable documents, audio-video presentations, interactive workbooks, web-based lectures, collaborative exercises, homework assignments, etc. In some instances, the materials may be provided as part of a certification program or other formal course of instruction.

Program module 402 includes sub-modules for child assessment 412, progress charts 414 and treatment plans 416. Collectively, these modules provide for assessing a subject child's mastered and non-mastered skills, determining a set of lessons from a specialized curriculum, which lessons define an individualized, ABA-based program of instruction (based on the needs of the subject child as identified by the assessment), and monitoring of the child's progress as he/she progresses through the lessons of the individualized program under the guidance of parents, therapists and others. Further details of the program module and its sub-modules are described in U.S. patent application Ser. No. 12/874,159, assigned to the assignee of the present invention. Such details are not required for an understanding of the present invention.

In one particular embodiment, e-Learning module 410 provides users (e.g., prospective educators for children with autism) an on-line training program. Upon logging into an e-Learning account, e.g., using a username and password combination established via the registration module, the user is presented with an e-Learning dashboard. The e-Learning dashboard provides quick access to various individual learning modules, each of which includes one or more lessons. The individual lessons are presented by way of audio-video programs which are viewable by the user. The user is also provided a facility to take notes while watching and listening to the lesson program and these notes can be stored on-line for later reference (e.g., a user may consult his/her notes during one or more quizzes and/or a final exam as part of a certification process). Notes can also be printed for hard copy reference. The e-Learning dashboard is automatically updated to reflect a user's progress through the training materials and any associated quizzes or exams. In some cases, users are not permitted to move on to new lessons until prerequisite lessons have been completed and/or the associated exams have been passed to a level sufficient to indicate mastery of the associated subject matter. Likewise, a user may not be permitted to take a final exam until he/she achieves a passing score on all quizzes.

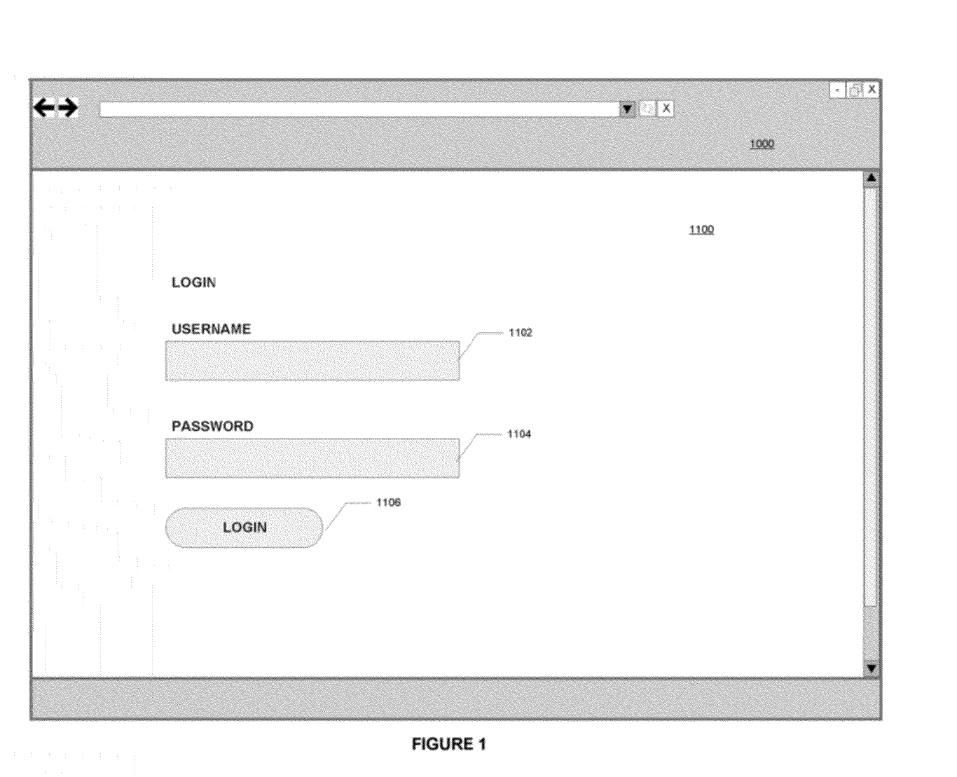

Turing now to FIG. 1, a portion of a user interface for the e-Learning module 410 is illustrated. In particular, FIG. 1 shows a login screen 1100 as it may be rendered within a web browser 1000 of a user's computing device, such as a client computer 102a-102n. As is known in the art, the login screen is an example of a web page, i.e., a computer data file on a host (such as server 104) operating a web server (e.g., 312). When the web server receives an inquiry from the client computer via Internet, it returns the web page to the computer making the inquiry. The web pages that make up the login screen and the other user interfaces discussed below are provided merely as examples of same, and should not be read or viewed as limiting the scope of the present invention. Selecting (or “clicking”) graphical or other elements within these user interfaces should be understood as the user executing a selection operation with a mouse, keyboard or other cursor control device when the on-screen cursor is highlighting or hovering over the element being selected. Doing so transmits a command to the server hosting the e-Learning system to perform the action(s) associated with the selected element (e.g., such as selecting a hyperlink, checking a check box or radio button, submitting a Web form, etc.).

Login screen 1100 is an example of a web form displayed as a web page by a browser in response to hypertext mark-up language (HTML) tags and other information received from a web server. An associated form handler resides at the server to collect and process the information submitted by a user via the form. By using such forms, an information collection process performed by the host is made interactive with the users thereof. That is, users can add text to text boxes (such as username and password fields 1102 and 1104), select from drop down menus and/or select check boxes and/or radio buttons, etc. Typically, the user submits the form by clicking on a submit button (such as login button 1106) or other appropriately labeled element of the form and, upon such submission, the contents of the form are passed to the form handler. Depending upon the type of information being submitted and the type of form handler being used, the information submitted by a user may be appended to a file maintained by the host, for example a file associated with a temporary account assigned to the user or a larger database. In this way information may be collected, processed and displayed to those who access it.

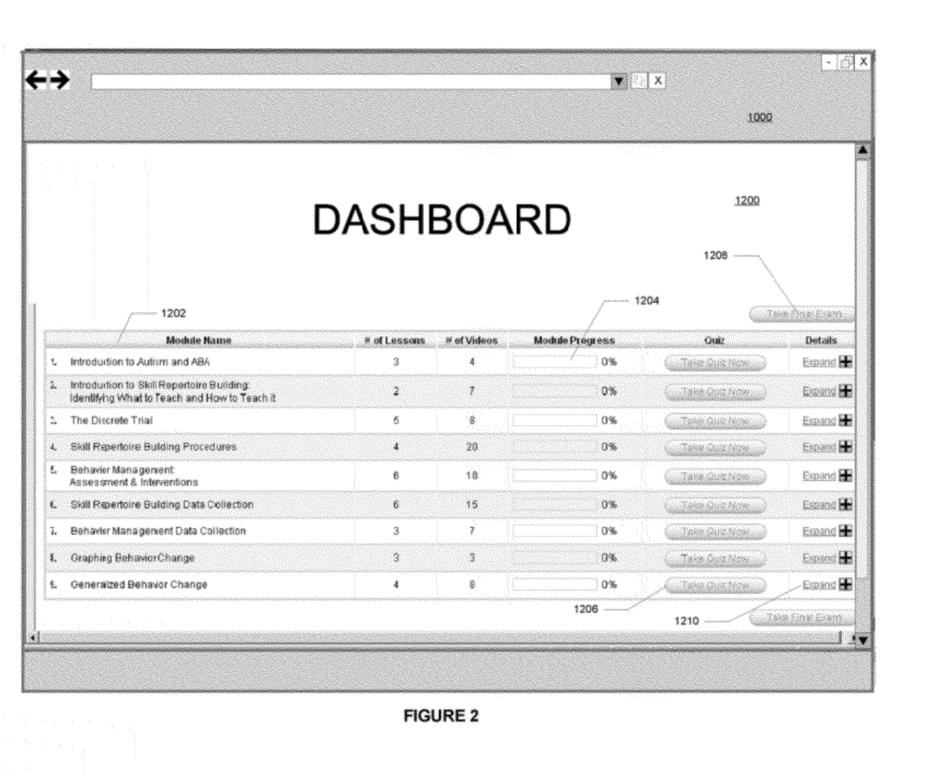

Once the user has logged-in to the e-Learning system, a dashboard is presented. An example of such a dashboard 1200 is shown in FIG. 2. The dashboard provides a list 1202 of training modules, each of which may be made up of one or more individual lessons, within the e-Learning environment. Users may have access to one or more e-Learning environments, each composed of different numbers of modules. In the present example, only a single e-Learning environment geared towards providing training materials for prospective behavioral educators of individuals (e.g., children) with developmental disorders. Such training materials can be used to instruct the prospective educators in ABA and how it is used to teach skills to said children, and to facilitate on-line assessment of the prospective educators' mastery of the subject matter of the training materials. Of course, this is only one example and other instantiations of the e-Learning system may have additional environments geared towards other training materials.

As shown in FIG. 2, the dashboard describes each training module by name and indicates the number of lessons and audio video presentations which comprise each module. Progress indicators 1204 are also provided to show where the user currently stands in terms of completion of each training module. Upon completion of all of the lessons of a module, the user is able to take a quiz regarding the subject matter of the module. Upon successful completion of all of the quizzes, the user may take a final examination. Dashboard 1200 includes buttons 1206 and 1208 to facilitate the user's election of taking a quiz or final examination, however, these buttons are rendered inoperative until such time as the user completes all prerequisites needed before the quiz or exam is administered. For example, the individual quiz buttons may be inoperative until such time as the user has completed all of the lessons of a corresponding module and the final exam button may be inoperative until the user has achieved passing grades on all quizzes of the e-Learning system. Prerequisites and successful completion thresholds may be established by a system administrator.

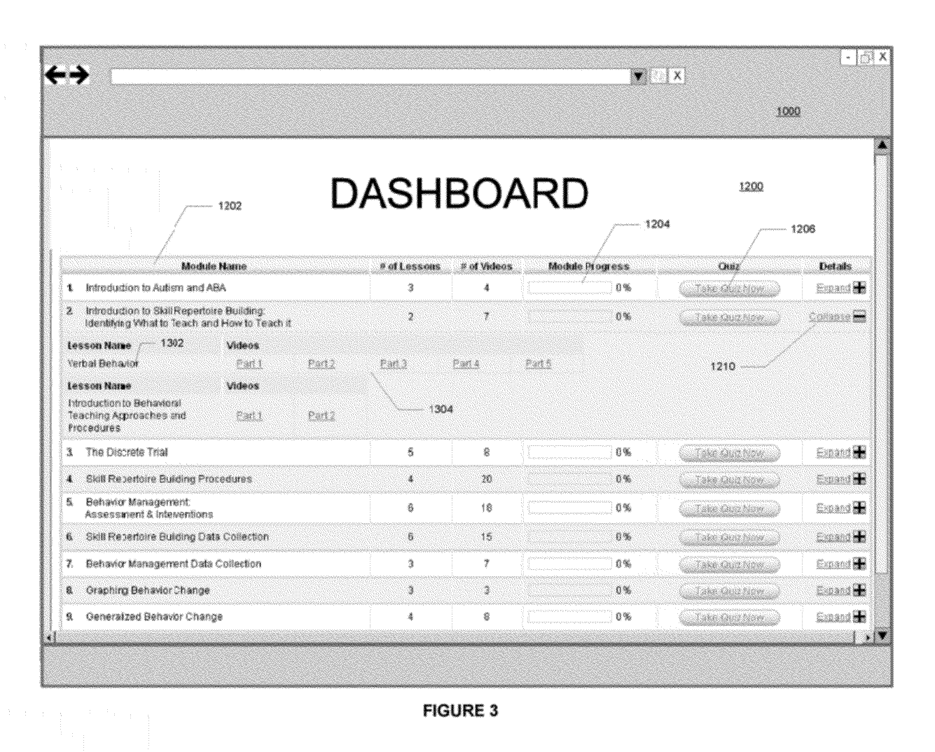

Links 1210 are provided to allow a user to explore the particulars of the individual training modules in more detail. When selected, as shown in FIG. 3, the link reverts to allow the user to collapse the listing. Each detailed module listing includes names of the individual lessons 1302 that make up the module and links 1304 to the individual audio-video presentations that make up each lesson. A lesson may have any number of audio-video or other presentations (e.g., some presentations may be reading assignments for the user).

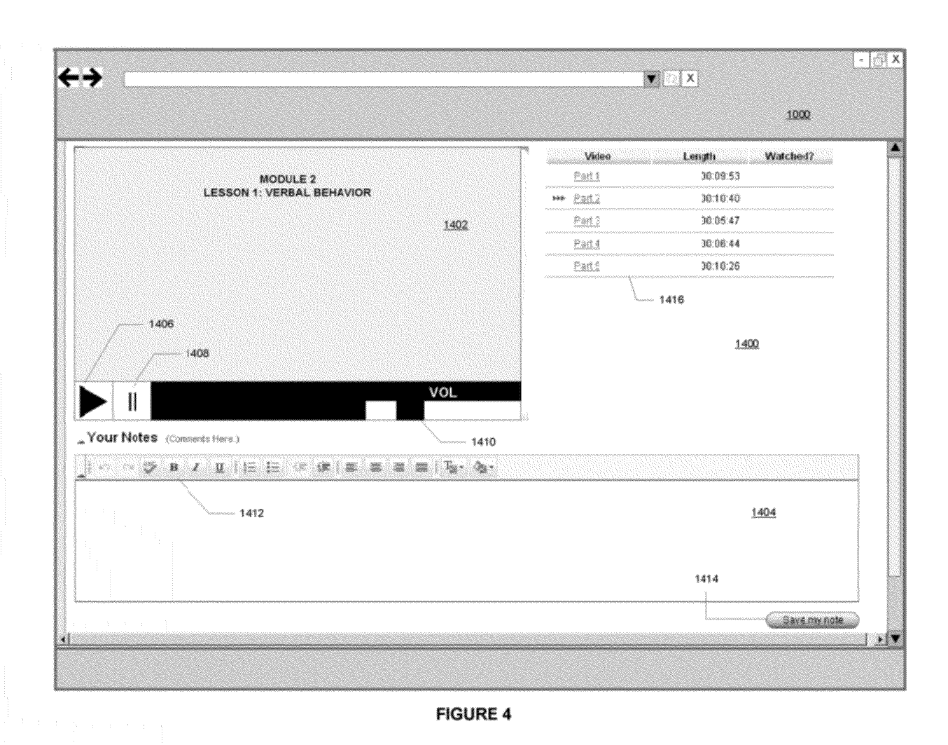

Selecting a link 1304 for an audio-video presentation associated with a lesson will cause the server to provide the user with a web page similar to that illustrated in FIG. 4. This video and notes page 1400 includes a window 1402 in which an audio-video presentation plays (e.g., within an embedded audio-video player), and a notes field 1404. The audio-video player includes play 1406, pause 1408 and volume 1410 controls, allowing the user to play and pause the lesson presentation and adjust the audio level according to the user's needs. Notes field 1404 allows the user to type personal notes while viewing the lesson materials and a toolbar 1412 provides familiar text editing and/or formatting tools in order for a user to customize the notes to his/her taste. Notes can be saved (by selecting save button 1414) for later review (e.g., while taking a quiz or exam), and the saved notes may be stored in database 108 or other storage location accessible to the e-Learning system. A menu 1416 allows the user to select a desired video of the lesson for playback and highlights the current lesson being viewed.

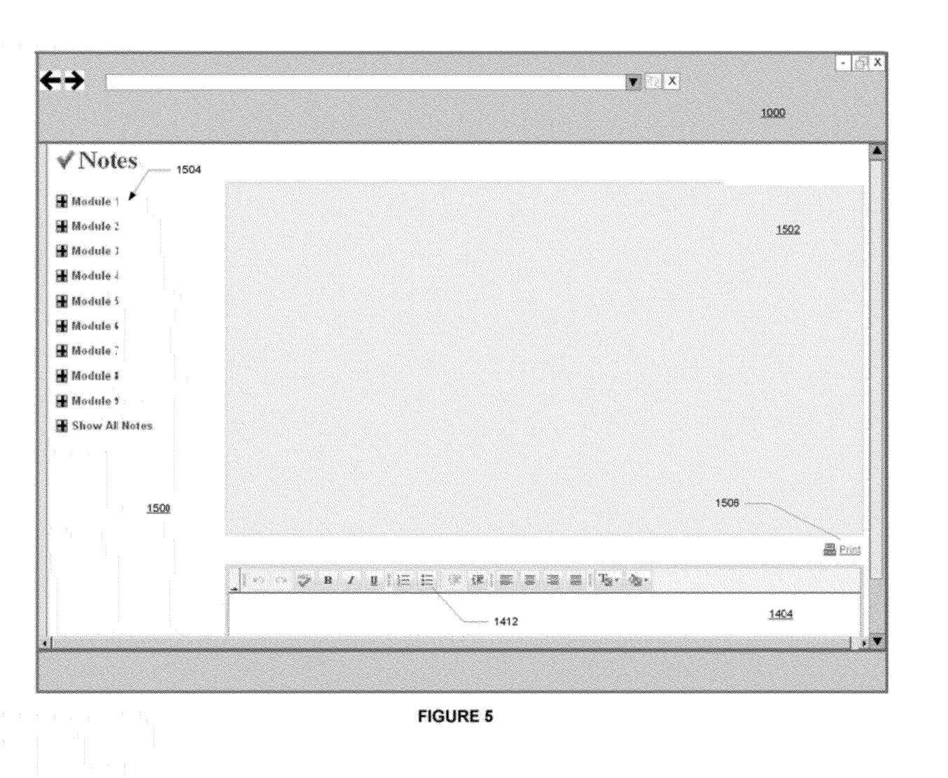

As shown in FIG. 5, a user can review and/or edit his/her notes at any time by opening a notes review page 1500. Note page 1500 includes a review panel 1502 where previously taken notes are presented in response to a user selection from menu 1504, which lists the various training modules. When a user selects one of the modules, or a lesson within a module, any associated notes that the user has previously taken and stored in connection with that module/lesson will be presented in the review panel 1502. An additional notes field 1404 is provided for the user to edit/revise the notes and/or add thereto. If desired, the user can print his/her notes by selecting a print icon 1506.

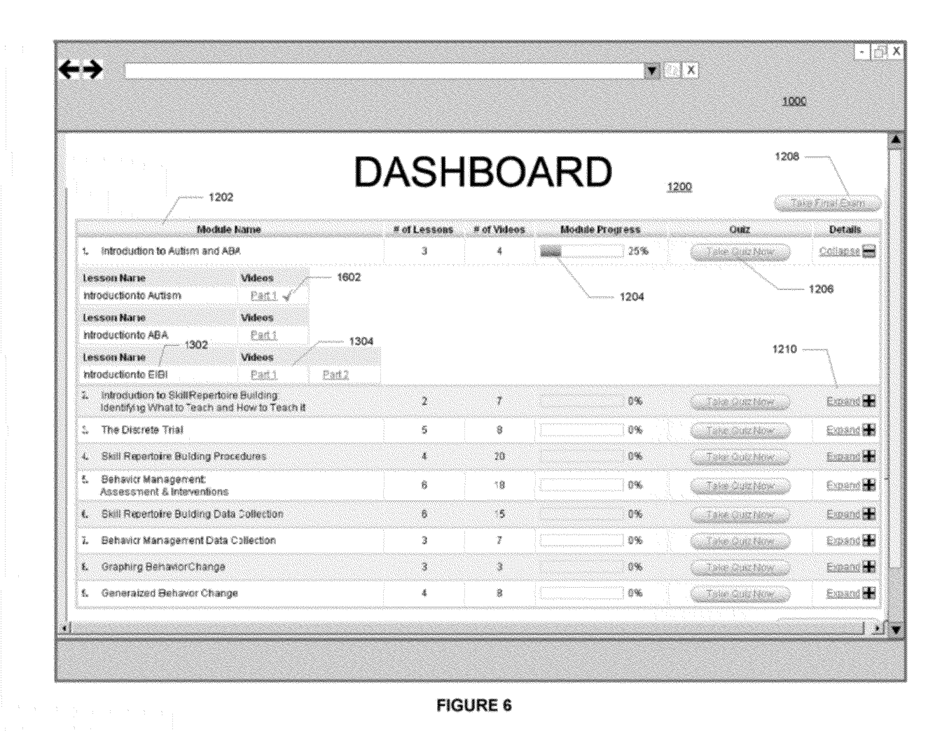

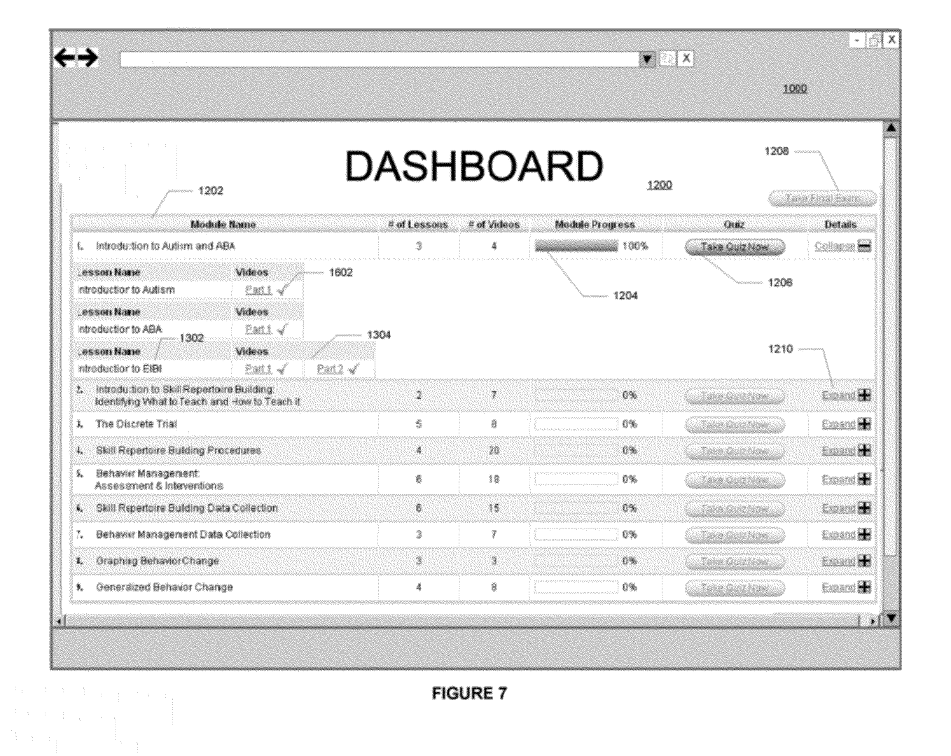

As shown in FIG. 6, as a user completes individual lessons, completion indicators 1602 are shown within the dashboard and the progress indicators 1204 are annotated accordingly. When all of the lessons in a module have been completed, see FIG. 7, the progress indicator 1204 indicates same and the associated quiz button 1206 is enabled for user selection.

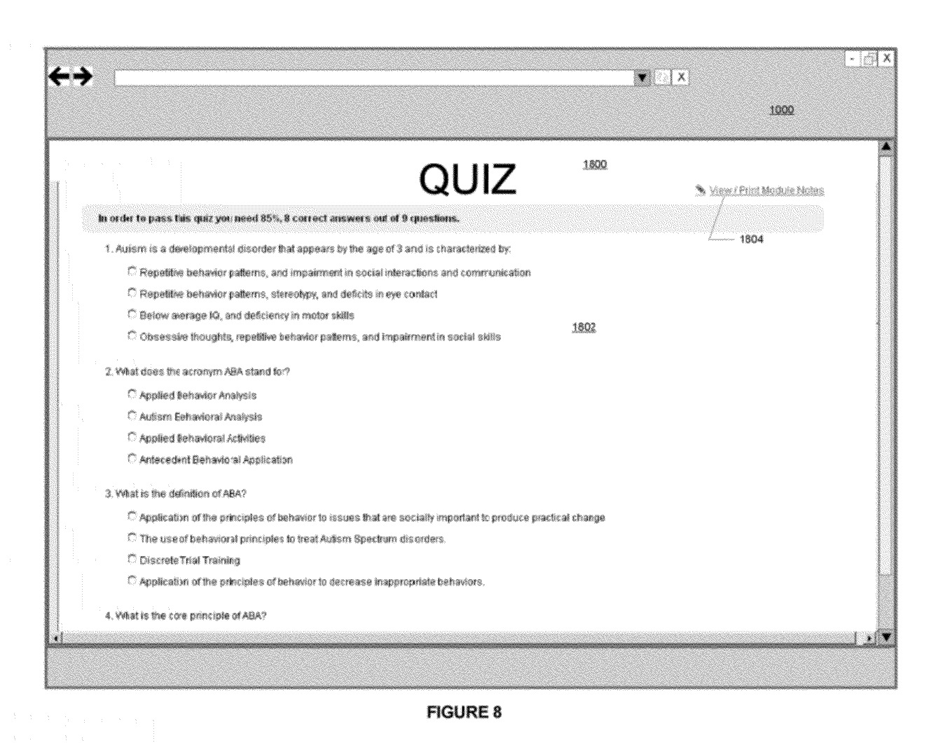

When a user selects the quiz button, the server provides the user with a quiz screen 1800, similar to that shown in FIG. 8. The quizzes 1802 consist of a series of true/false and/or multiple choice questions based on the content of the associated training module. A link 1804 affords the user an opportunity to review/print his/her notes while taking the quiz and the notes may be presented in a pop up window, as a new tab or window in the browser, or the user may be linked to the notes review page 1500.

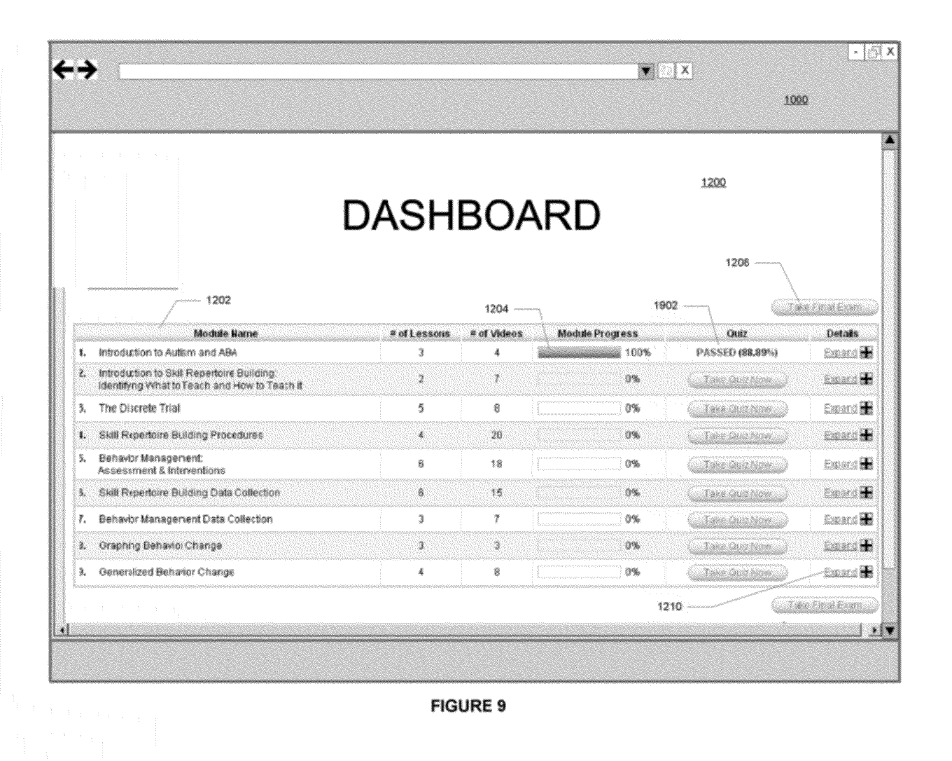

Using a cursor control device, for each question of the quiz the user selects the answers he/she believes to be correct and, when all of the questions have been answered, submits his/her responses to be graded. The server then returns the results of the quiz and, in the event the user has not successfully answered the quiz to a degree sufficient to indicate mastery of the associated subject matter, may afford the user an opportunity to retake the quiz, retake only those questions answered incorrectly, or to review the lesson material again before retaking the quiz. Of course, different embodiments of the present invention may provide for any or all of these eventualities. Eventually, once the user has successfully completed the quiz, the dashboard is updated to reflect successful completion 1902, as shown in FIG. 9.

Once the user has successfully completed all of the quizzes, a final exam may be administered in a similar manner. The final exam may be comprehensive in terms of the subjects of the various lessons and upon successful completion of the, final exam the user may be afforded the opportunity to create student lesson plans using other facilities of server application 310. Of course, a user need not complete all lessons, quizzes and exams in a single session. Facilities are provided for a user to save his/her notes and to log out of the system for later return. Server application 310 stores the results showing the user's progress through the lesson materials so that when the user returns during a subsequent session, he/she need not restart the training session from the beginning but can pick up wherever he/she left off. In general, training materials need not necessarily be studied in a particular order, unless there are designated prerequisites that require completion before the user is permitted to view other materials which rely on same. For example, if a lesson is broken up into multiple audio video presentations, the user may be required to view the presentations in a designated order so that basic material needed to understand more advanced concepts are learned before the user is exposed to those advanced concepts.

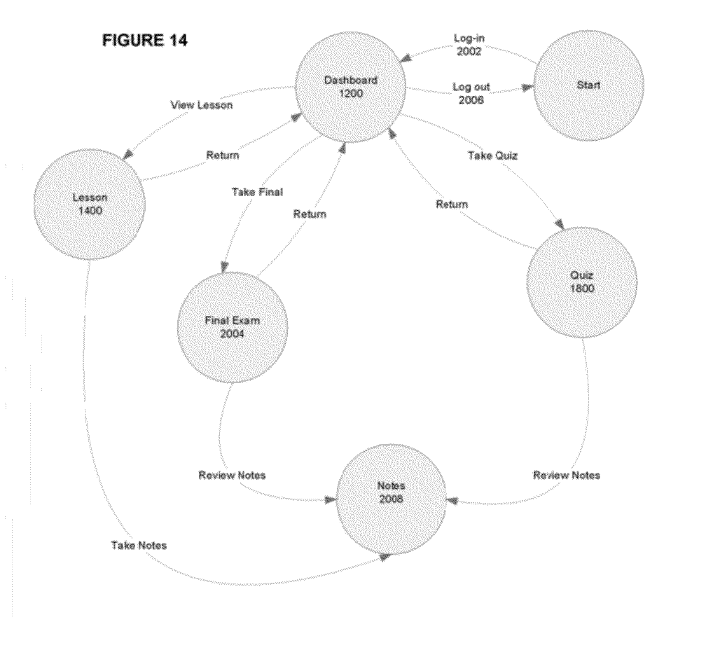

FIG. 14 provides an overview of some of the navigation options available within the e-Learning system. Upon logging in 2002, the user is provided with his/her dashboard 1200. From the dashboard, the user can view a lesson on a lesson page 1400, take a quiz at a quiz page 1800, or take the final exam 2004. The user can also log out of the system 2006. During a lesson, a user can take notes 2008, which can be reviewed during a quiz or the final exam.

Thus, computer-based methods and systems for providing training materials for educators and, in one particular embodiment, for providing such materials to prospective behavioral educators of individuals (e.g., children) with developmental disorders, have been described.

What is claimed is:

1. A computer-based system, comprising: a processor and a storage medium communicatively coupled to said processor, said storage medium storing instructions, which when executed by said processor cause said processor to execute an e-Learning module configured to provide a client computer system with a web page configured as a dashboard that is adapted to permit user navigation to a multiplicity of lessons, each such lesson having an associated web page that includes a viewing area for an audio-video program and a text field adapted to permit a user to enter notes which watching the audio-video program.

2. The computer-based system of claim 1, wherein the dashboard is further configured to permit user navigation to individual quizzes associated with each of the lessons.

3. The computer-based system of claim 2, wherein graphical elements to facilitate user navigation to a respective one of the individual quizzes is enabled on the dashboard only after all prerequisites for the respective one of the individual quizzes have been completed.

4. The computer-based system of claim 2, wherein the dashboard is further configured to permit user navigation to a final exam which is comprehensive for all of the lessons.

5. The computer-based system of claim 4, wherein a graphical element to facilitate user navigation to the final exam is enabled on the dashboard only after all of the individual quizzes have been successfully completed.

6. The computer-based system of claim 1, wherein the dashboard is configured to graphically depict user progress through the individual lessons.

7. The computer-based system of claim 3, wherein the dashboard is configured to graphically depict successful user completion of the individual quizzes.

8. The computer-based system of claim 2, wherein the notes are accessible by a user while taking one of the quizzes.

9. The computer-based system of claim 4, wherein the notes are accessible by a user while taking the final exam.

10. The computer-based system of claim 1, wherein the lessons comprise training materials for prospective behavioral educators of individuals with developmental disorders.
